(19) United States
(12) Patent Application Publication
(10) Pub. No.: US 2015/0153759 A1
(43) Pub. Date: Jun. 4, 2015

(54) Sliding rod structure

(71) Applicant: Sheng-Syong He, Pingtung (TW)

(72) Inventor: Sheng-Syong He, Pingtung (TW)

(21) Appl. No.: 14/096,034

(22) Filed: Dec. 4, 2013

(51) Int. Cl. G05G 1/06

(52) U.S. Cl. CPC G05G 1/06

(57) ABSTRACT

A sliding rod structure is provided with a rod and a sheath. The rod includes an end body and a threaded portion formed separately at both ends of the rod. The sheath has a receiving space and bearings are installed separately in the inner sides of both ends of the sheath so that the sheath can be placed over the rod and is slidably on the rod. The sliding rod structure is applicable to the brakes or the clutch of a motorcycle. The sheath is still slidably free while being placed over the rod. Friction generated when the sheath is pressed can be reduced. At the same time, discomfort to hands caused by the friction generated between the rod and the sheath while being pressed can be avoided.

### BACKGROUND OF THE INVENTION

1. Field of the Invention

The invention relates to sliding rod structures and more particularly to a sliding rod structure applicable to the brakes or the clutch of a motorcycle.

2. Description of Related Art

Motorcycle is a very popular means of transportation these days. Every motorcycle generally uses a rod to operate the brake or the clutch. However, these rods mostly are stationary rods where drivers' hands apply force to, leading to hand muscles sore caused by the compression after a long period of time. As a result, it is difficult to effectively control the break rod and to manage a timely stop.

Thus, the need for improvement still exists.

### SUMMARY OF THE INVENTION

It is therefore one object of the invention to provide a sliding rod structure which can reduce the friction generated while the rod is pressed, through the effect of using a slidable sheath placed over the rod and, at the same time, to avoid the uncomfortable feeling to the hand from pressing and rubbing the rod and sheath.

According to the object described above, the invention provides a sliding rod structure comprising a rod and a sheath wherein the rod includes an end body and a threaded portion, wherein the sheath has a receiving space and bearings are installed separately in the inner sides of both ends of the sheath so that the sheath can be placed over the rod and is slidably on the rod, wherein the sheath is covered with a sheath body, wherein the sheath body is made of rubber materials, wherein the rod is made of aluminum alloy materials, wherein the sheath is made of aluminum alloy materials, wherein both ends of the rod are covered with pads, and wherein the rod structure is a motorcycle rod structure.

Thus, based on the description above, the sliding rod structure of the invention is mainly installed in front of the motorcycle handlebar as the motorcycle rod wherein the motorcycle rod is applicable to the brakes or the clutch. When the user presses the sheath placed over the rod, the rod and the sheath can slide between each other driven by the hand's movement, reduce the friction generated while the rod being pressed and, at the same time, avoid the uncomfortable feeling to the hand from pressing and rubbing the rod and sheath.

Further, the pads on both ends of the rod are placed over the rod along with the sheath at the same time, in order to prevent damages caused by the long-term friction between the sheath and the rod.

The above and other objects, features and advantages of the invention will become apparent from the following detailed description taken with the accompanying drawings.

### BRIEF DESCRIPTION OF THE DRAWINGS

FIG. 1 is a schematic exploded view of a sliding rod structure according to a first preferred embodiment of the invention;

FIG. 2 is a schematic view of the invention;

FIG. 3 is a schematic diagram of the invention mounted on a motorcycle;

FIG. 4 is a schematic view of a first operation of the invention;

FIG. 5 is a schematic view of a second operation of the invention; and

FIG. 6 is a schematic view of a sliding rod structure according to a second preferred embodiment of the invention mounted on a motorcycle.

### DETAILED DESCRIPTION OF THE INVENTION

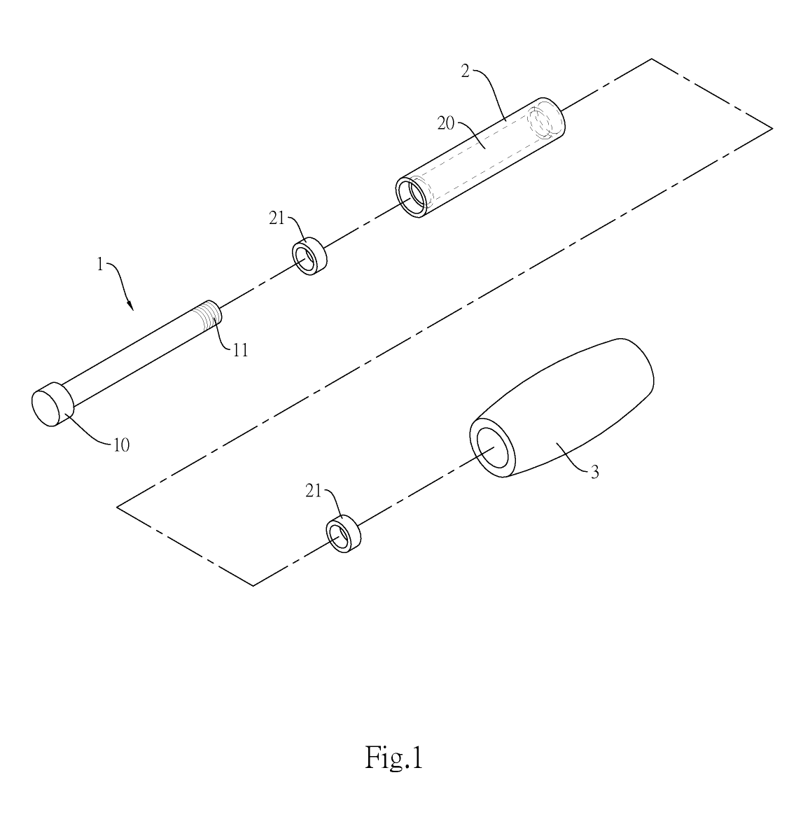

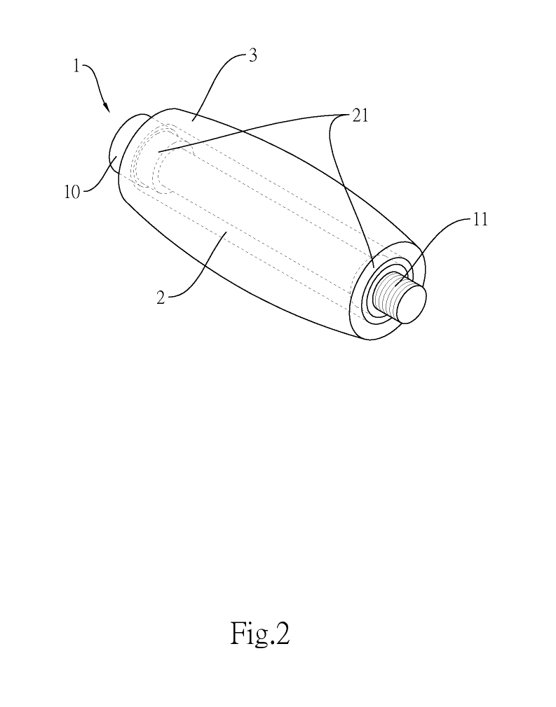

Referring to FIGS. 1 and 2, according to the figures, a sliding rod structure of a first preferred embodiment of the invention comprises a rod 1 and a sheath 2 wherein the rod 1 includes an end body 10 and a threaded portion 11 formed separately at both ends of the rod, and wherein the sheath 2 has a receiving space 20 and bearings 21 are installed separately in the inner sides of both ends of the sheath 2 so that the sheath 2 can be placed over the rod 1 and is slidably on the rod 1. The rod 1 and the sheath 2 are made of aluminum alloy materials wherein the sheath 2 can be covered with a sheath body 3 which has the slip prevention function and is made of rubber materials.

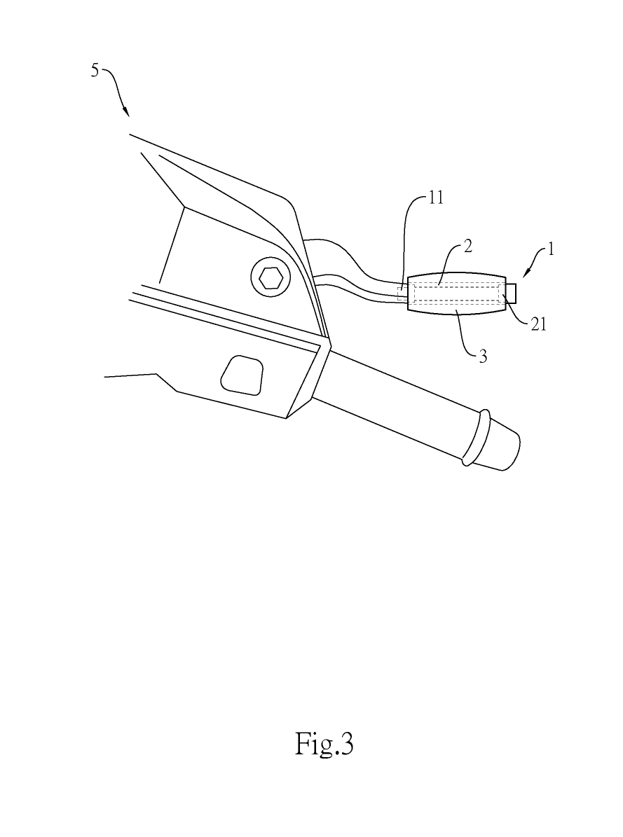

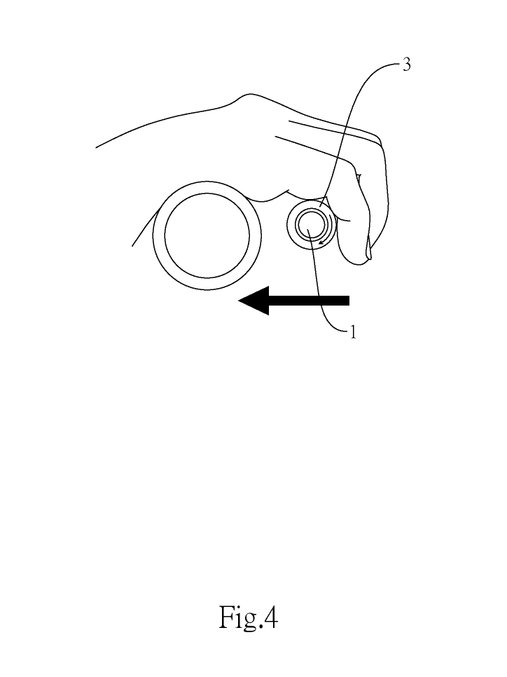

Referring to FIGS. 3 and 4, according to the figures, the sliding rod structure of the invention is installed to a motorcycle 5 mainly through the threaded portion 11 wherein the rod 1 has the sheath 2 and the sheath body 3 mounted thereon, and is used as the motorcycle rod wherein the motorcycle rod is applicable to the brakes or the clutch.

When the user presses the sheath body 3 covered on the sheath 2, through the bearings 21 installed in the inner sides of the sheath 2 and in contact with the rod 1, the sheath body driven by the hand's movement slides thus to reduces the friction generated while the rod being pressed and, at the same time, to avoid the uncomfortable feeling to the hand from pressing the rod 1 and the sheath 2.

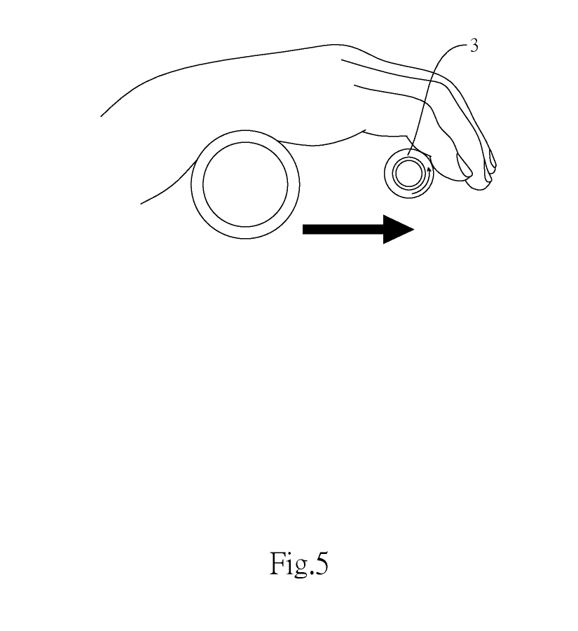

Referring to FIG. 5 in conjunction with FIG. 3, according to the figures, after the user releases the brake or the clutch, the rod structure installed in the motorcycle 5 can slide along through the contact made by the hand to the sheath body 3, thus to reduce the friction between the hand and the sheath body 3.

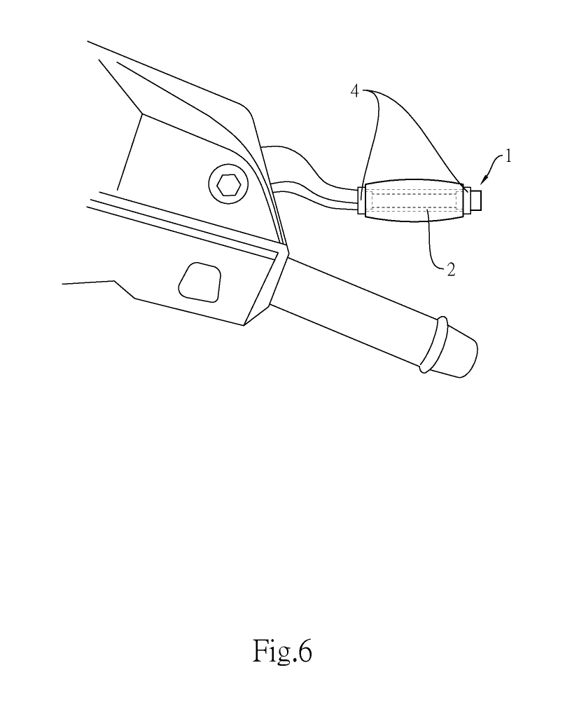

Referring to FIG. 6, a sliding rod structure of a second preferred embodiment of the invention is provided. According to the figure, both ends of the sheath 2 are covered with pads 4 separately wherein the pads 4 can prevent the friction damage between the rod 1 and the sheath 2 in order to extend the usage lifetime of the rod 1 and the sheath 2.

Accordingly, the sliding rod structure of the invention is mainly applicable to the motorcycle brakes or the clutch, reduces the friction generated while the rod being pressed through the effect of using a freely slidable sheath placed over the rod and, at the same time, avoids the hand muscle sore from long-term pressing move.

While the invention has been described in terms of preferred embodiments, those skilled in the art will recognize that the invention can be practiced with modifications within the spirit and scope of the appended claims.

What is claimed is:

1. A sliding rod structure, comprising:
a rod including an end body and a threaded portion formed separately at both ends of the rod; and
a sheath having a receiving space and bearings installed separately in inner sides of both ends of the sheath so that the sheath can be placed over the rod and is slidably on the rod.

2. The sliding rod structure of claim 1, wherein the sheath can be covered with a sheath body.

3. The sliding rod structure of claim 2, wherein the sheath body is made of rubber materials.

4. The sliding rod structure of claim 1, wherein the rod is made of aluminum alloy materials.

5. The sliding rod structure of claim 1, wherein the sheath is made of aluminum alloy materials.

6. The sliding rod structure of claim 1, wherein both ends of the rod are covered with pads.

7. The sliding rod structure of claim 1, wherein the rod structure is a motorcycle rod structure.

8. The sliding rod structure of claim 7, wherein the motorcycle rod structure is applicable to the brakes or the clutch.
